(19) United States
(12) Patent Application Publication
(10) Pub. No.: US 2007/0197687 A1
(43) Pub. Date: Aug. 23, 2007

(54) Low Specific Gravity Unsaturated Polyester Resin Compositions For Lamp Reflectors And Molded Articles Thereof

(75) Inventors: Kunio Yamane, Hyogo (JP); Nobuhito Hagiwara, Hyogo (JP); Shotaro Itami, Hyogo (JP); Hidekazu Kaneoka, Hyogo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA HIGHPOLYMER CO., LTD., TTOKYO (JP)

(21) Appl. No.: 10/593,633

(22) PCT Filed: Mar. 9, 2005
(86) PCT No.: PCT/JP05/04107

§ 371 Date: Sep. 21, 2006

(51) Int. Cl. C08J 9/32

(52) U.S. Cl. 523/218; 524/604

(57) ABSTRACT

An object of the present invention is to obtain low specific gravity unsaturated polyester resin compositions for lamp reflectors and molded articles thereof, which have a low and invariant specific gravity, and excellent surface smoothness, heat resistance, rigidity, dimensional accuracy, moldability, etc.

The compositions comprise from 40 to 210 parts by weight of an inorganic filler having an average particle size of at least 0.5 μm and from 30 to 160 parts by weight of a hollow filler having a pressure resistance of at least 2,100×10⁴ N/m² of based on 100 parts by weight of an unsaturated polyester resin and a crosslinking agent wherein the addition ratio by weight of the inorganic filler to the hollow filler lies within a range of 2:8 to 8:2.

### TECHNICAL FIELD

The present invention relates to unsaturated polyester resin compositions for lamp reflectors and molded articles thereof. More particularly, it relates to unsaturated polyester resin compositions for lamp reflectors typified by automotive head lamps, and molded articles thereof.

### BACKGROUND ART

Conventionally, unsaturated polyester resin molding materials (bulk molding compounds: BMC) have excellent mechanical strength, rigidity, surface smoothness, dimensional accuracy, heat resistance and moldability, so that they are widely used for OA equipment, chassis for office equipment, lamp reflectors typified by automotive head lamps, etc.

However, while molded articles having excellent mechanical strength, rigidity, surface smoothness, dimensional accuracy and heat resistance can be obtained with conventional unsaturated polyester resin molding materials using cured molding, problems of increased specific gravity of the molded article due to the amount of inorganic filler and fiber reinforcement contained in order to retain these excellent properties have appeared. Also, as the specific gravity of molded articles become higher even compared to thermoplastic resins, the area of use thereof has been restricted so far.

In order to resolve the above problem, various methods for obtaining low specific gravity have been considered. Examples of typical methods for low specific gravity include the reduction of fillers and reinforcement, the addition of fillers having relatively low specific gravity such as aluminum hydroxide, etc., and the addition of hollow fillers typified by glass balloon and silica balloon (for example, refer to Patent document 1).

However, when restricted to only lamp reflectors in particular, if such fillers having relatively low specific gravity are added, heat resistance may decrease, blisters and cracks may occur when such molded articles are coated or have deposits made thereon, and blisters of the deposition surface may occur upon aging and discoloration thereof may increase. Further, there are many problems in that glossiness and surface smoothness such as leveling remarkably decrease, the mechanical strength of the molded article is greatly reduced, and moldability decreases, for example from pores, haze and sink marks occur in the injection molding.

Also, if standard hollow fillers are merely added, the destruction of the hollow fillers occurs when the resin molding materials are metered and injected in the injection molding, and variations in specific gravity between some parts of the molded article or between each of the molded articles occur, thereby resulting in warping and deformation of the molded article. Further, such warping and deformation result in distortions in the light distribution in lamp reflectors. Furthermore, there are the problems such as the occurrence of blisters and cracks, the reductions in surface smoothness, the fiber reinforcements floating to the surface and decreases in moldability owing to the decreased heat resistance, so that the resin molding materials are not used in lamp reflectors typified by automotive head lamps.

Patent document 1: Japanese Patent Laid-open No. 2001-261954

### DISCLOSURE OF THE INVENTION

### Problems to be Solved by the Invention

Accordingly, an object of the present invention is to provide low specific gravity unsaturated polyester resin compositions for lamp reflectors and molded articles thereof, which have low and invariant specific gravity and excellent surface smoothness, heat resistance, mechanical strength, rigidity, dimensional accuracy and moldability.

### Means for Solving the Problems

The inventors of the present invention as a result of earnest investigation have achieved the above object. As a result, the inventors have found that the above problems can be resolved by adding certain inorganic fillers and certain hollow fillers at certain ratios to polyester resin.

That is, low specific gravity unsaturated polyester resin compositions for lamp reflectors of the present invention are characterized by comprising from 40 to 210 parts by weight of an inorganic filler having an average particle size of at least 0.5 Mm and from 30 to 160 parts by weight of a hollow filler having a pressure resistance of at least 2,100×10⁴ N/m² based on a total of 100 parts by weight consisting of an unsaturated polyester resin and a crosslinking agent, wherein the addition ratio by weight of the inorganic filler to the hollow filler lies within a range of 2:8 to 8:2.

Further, molded articles of the present invention are characterized by being obtained by molding the above low specific gravity unsaturated polyester resin compositions for lamp reflectors.

In addition, the molded articles preferably have a molding shrinkage ratio of −0.15 to +0.05%, a coefficient of linear expansion of 1.0×10⁻⁵/K to 2.5×10⁻⁵/K, Barcol hardness of 5 to 25 when heated at 180° C. and a specific gravity of 1.00 to 1.60.

### EFFECT OF THE INVENTION

According to the present invention, low specific gravity unsaturated polyester resin compositions for lamp reflectors and molded articles thereof, which have low and invariant specific gravity and excellent surface smoothness, heat resistance, mechanical strength, rigidity, dimensional accuracy and moldability can be provided by including certain inorganic fillers and hollow fillers in specified amounts.

### BRIEF DESCRIPTION OF THE DRAWINGS

FIG. 1 is a plane view illustrating a Test box used in the Examples.

FIG. 2 is a cross-sectional view illustrating the A-A′ line of FIG. 1.

### BEST MODE FOR CARRYING OUT THE INVENTION

Low specific gravity unsaturated polyester resin compositions for lamp reflectors of the present invention comprise from 40 to 210 parts by weight of an inorganic filler having an average particle size of at least 0.5 Mm and from 30 to 160 parts by weight of a hollow filler having a pressure resistance of at least 2,100×10⁴ N/m² based on 100 parts by weight of an unsaturated polyester resin and a crosslinking agent wherein the addition ratio by weight of the inorganic filler to the hollow filler lies within a range of 2:8 to 8:2.

The kind of unsaturated polyester resin used in the present invention is not limited especially. For the unsaturated polyester resin used in the present invention, appropriate resins which polycondense a polyalcohol with an unsaturated polybasic acid and/or a saturated polybasic acid, and are usually used as a molded material can be used. Also, a vinyl ester resin and a diallyl phthalate resin may be blended as a part of the unsaturated polyester resin.

Examples of polyalcohols which can form the unsaturated polyester resin include ethylene glycol, propylene glycol, neopentyl glycol, butanediol, diethylene glycol, dipropylene glycol, triethylene glycol, pentanediol, hexanediol, neopentanediol, hydrogenated bisphenol A, bisphenol A, glycerin, etc. Propylene glycol, neopentyl glycol and bisphenol A or hydrogenated bisphenol A are preferable in view of heat resistance, mechanical strength, moldability, etc.

Examples of the unsaturated polybasic acid include maleic anhydride, fumaric acid, citraconic acid, itaconic acid, etc. Also, examples of the saturated polybasic acid include phthalic anhydride, isophthalic acid, terephtalic acid, chlorendic acid, succinic acid, adipic acid, sebacic acid, tetrachloro phthalic anhydride, tetrabromo phthalic anhydride, endmethylenetetrahydro phthalic anhydride, etc. Among them, unsaturated polybasic acid is preferable, and maleic anhydride and fumaric acid are more preferable in view of heat resistance, mechanical strength, moldability, etc.

Further, in view of further improving the heat resistance, mechanical strength, moldability, etc., it is preferable to use an unsaturated polyester resin composition obtained by polycondensing a total of 100 moles consisting of 20 to 50 moles of propylene glycol, 25 to 65 moles of neopentyl glycol and 15 to 25 moles of bisphenol A or hydrogenated bisphenol A based on 100 moles of at least one unsaturated polybasic acid selected from a group formed from fumaric acid and maleic anhydride.

As the crosslinking agent, appropriate agents having a polymeric double bond which can polymerize with the above unsaturated polyester can be used. Examples of the crosslinking agent include styrene monomer, diallylphthalate monomer, diallylphthalate prepolymer, methyl methacrylate, triallylisocyanurate, etc. The amount of the crosslinking agent is 25 parts by weight or more, preferably 35 parts by weight or more, and 70 parts by weight or less, preferably 65 parts by weight or less, based on 100 parts by weight of the unsaturated polyester resin and the crosslinking agent, in view of workability, polymeric property, and shrinkage property of the molded article and flexibility of the addition amount.

Also, from the view of improving coating properties, it is preferable to use an unsaturated polyester resin composition comprising from 35 to 75 parts by weight, more preferably 45 to 65 parts by weight of the crosslinking agent based on a total of 100 parts by weight consisting of the unsaturated polyester resin and the crosslinking agent, said crosslinking agent comprised of diallylphthalate monomer or prepolymer (A) and a crosslinking agent other than diallylphthalate monomer (B) wherein the ratio by weight of the (A) to (B) lies in a range of 5:95 to 25:75, more preferably 10:90 to 20:80.

The inorganic filler of the present invention has an average particle size of at least 0.5 μm or more. If the average particle size of the inorganic filler is less than 0.5 μm, the viscosity becomes high, or the destruction of the hollow filler occurs and thereby the specific gravity of the molded article becomes high, and therefore the moldable resin cannot be obtained. The average particle size of the inorganic filler is preferably 0.7 μm or more, most preferably 1.8 μm or more, in view of the moldability. Reversely, the average particle size of the inorganic filler is preferably 15 μm or less, more preferably 10 μm or less, in view of the surface smoothness and mechanical strength of the molded article. If the average particle size of the inorganic filler is more than 15 μm, it is not preferable because the surface smoothness and mechanical strength of the molded article remarkably decrease or fluidity of the material decreases and thereby the moldability decreases.

Further, the inorganic filler used in the present invention is preferably calcium carbonate, in view of the surface smoothness in the resin composition.

The amount of the inorganic filler is 40 parts by weight or more, preferably 50 parts by weight or more, and 210 parts by weight or less, preferably 160 parts by weight or less, based on 100 parts by weight of the unsaturated polyester and the crosslinking agent. If the amount of the inorganic filler is less than 40 parts by weight, the moldability decreases, and the pores and the floats of the fiber reinforcements arise in the molded article and thereby sufficient surface smoothness cannot be obtained, and also mechanical strength considerably decreases. Reversely, if the amount of the inorganic filler is more than 210 parts by weight, the specific gravity of the molded article becomes high.

As the inorganic filler powder, material such as calcium carbonate, aluminum hydroxide, wallastonite, clay, talc, mica, silicic acid anhydride, etc. can be used according to need.

The hollow filler of the present invention has a pressure resistance of at least 2,100×10⁴ N/m², and includes but is not limited to glass balloon, silica balloon, alumina balloon, etc. If the pressure resistance is less than 2,100×10⁴ N/m², the heat resistance and mechanical strength decrease, and the hollow filler is destroyed in production step and molding step and thereby the specific gravity of the molded article cannot become low. The pressure resistance is preferably 2,800×10⁴ N/m² or more.

Preferably, the hollow filler also has a true specific gravity of the range of 0.3 to 0.7. If the true specific gravity is less than 0.3, it is not preferable because the viscosity increases, so that the addition amount of the inorganic filler should be decreased, and thereby the moldability decreases and the surface smoothness and mechanical strength of the molded article are reduced considerably. Reversely, if the true specific gravity is more than 0.7, it is not preferable because the specific gravity of the molded article cannot become low.

Further, the hollow filler preferably has an average particle size of 80cm or less, in view of the surface smoothness of the resin composition.

The amount of the hollow filler is 30 parts by weight or more, preferably 40 parts by weight or more, and 160 parts by weight or less, preferably 150 parts by weight or less, based on 100 parts by weight of the unsaturated polyester resin and the crosslinking agent. If the amount of the hollow filler is more than 160 parts by weight, the viscosity increases, so that the addition amount of the inorganic filler should be decreased, thereby decreasing the moldability and considerably decreasing the surface smoothness and mechanical strength of the molded article. Reversely, if the amount of the hollow filler is less than 20 parts by weight, the specific gravity of the molded article becomes high.

The unsaturated polyester resin composition comprises the inorganic filler and the hollow filler, wherein the addition ratio by weight of the inorganic filler to the hollow filler is in the range of 2:8 to 8:2. If the addition ratio by weight is outside of the above range and much hollow filler is added, the mechanical strength decreases considerably. Also, float, etc. of the fiber reinforcement arises, and thereby sufficient surface smoothness cannot be obtained. If much inorganic filler is added, the specific gravity of the molded article becomes high. Preferably, the addition ratio by weight of the inorganic filler to the hollow filler is from 4:6 to 7.5:2.5, in view of the mechanical strength.

In the unsaturated polyester resin composition of the present invention, if necessary, low constrictive agents, curing agents, mold lubricants, thickeners, fiber reinforcements, pigments, viscosity decreasing agents, etc. may be used together with the above ingredients. If these ingredients are used, each of the ingredients is added to the unsaturated polyester resin composition in amounts which are normally used according to various purposes.

As the low constrictive agent, one or more thermoplastic polymers which are generally used as low constrictive agents such as polystyrene, polymethyl methacrylate, polyvinyl acetate, saturated polyester, styrene-butadiene type rubber, etc. can be used.

As the curing agent, an appropriate peroxide can be used. Examples of the peroxide include t-butyl peroxyoctoate, benzoyl peroxide, 1,1-di-t-butylperoxy-3,3,5-trimethyl cyclohexane, t-butylperoxyisopropylcarbonate, t-butylperoxybenzoate, dicumylperoxide, di-t-butylperoxide, etc.

As the mold lubricant, for example, stearic acid, zinc stearate, calcium stearate, aluminum stearate, magnesium stearate, carnauba wax, etc. can be used in appropriate amounts.

Examples of the thickener include metal oxides such as magnesium oxide, magnesium hydroxide, calcium hydroxide and calcium oxide, etc., and isocyanate compounds. The thickener need not always be used.

As the fiber reinforcement, chopped strand glass cut to about 1.5 to 25 mm fiber length can be used. Also, organic and inorganic fibers such as pulp fiber, Tetoron® fiber, vinylon fiber, carbon fiber, aramid fiber, wallastonite, etc. can be used as the fiber reinforcement.

The unsaturated polyester resin composition of the present invention constituted by the above ingredients can be obtained using normal mixing methods, for example by using kneaders, etc.

The molded articles of the present invention can be obtained from the unsaturated polyester resin composition of the present invention. As the molded articles have excellent physical properties as mentioned above, the articles have low and invariant specific gravity, and also show excellent physical properties such as mechanical strength, rigidity, surface smoothness, dimensional accuracy, heat resistance, moldability, etc., thereby being provided with a high level of the properties required of lamp reflectors.

Preferably, the molded articles have a molding shrinkage ratio of −0.15 to +0.05%, a coefficient of linear expansion of 1.0×10⁻⁵/K to 2.5×10⁻⁵/K, Barcol hardness of 5 to 25 when heated at 180° C. and specific gravity of 1.00 to 1.60. In such molded articles, deformation from heating and aging becomes small.

The molding shrinkage ratio is measured at a molding temperature of 150° C. under a molding pressure of 10 MPa for a molding time of 3 minutes, according to JIS K6911. If the molding shrinkage ratio is less than −0.15%, it becomes difficult to pull the molded article out from the mold in the molding step. Reversely, if the molding shrinkage ratio is more than +0.05%, it is not preferable because the surface smoothness decreases. Also, the molded articles preferably have a molding shrinkage ratio of −0.12 to 0.00, in view of the surface smoothness and moldability.

The coefficient of linear expansion is measured at a molding temperature of 150° C. under a molding pressure of 10 MPa for a molding time of 3 minutes, according to JIS K6911. If the coefficient of linear expansion is more than 2.5×10⁻⁵/K, it is not preferable because deformations and cracks in the molded articles arise at heating. Also, the molded articles preferably have a coefficient of linear expansion of 1.1×10⁻⁵/K to 2.0×10⁻⁵/K, in view of dimensional accuracy.

The Barcol hardness is measured by a Barcol hardness tester (Barbaer-Colman Co., Ltd.; GYZJ934-1) at a molding temperature of 150° C. under a molding pressure of 10 MPa for a molding time of 3 minutes, according to JIS K6911. If the Barcol hardness is less than 5, it is not preferable because the leveling decreases and deformation of the molded articles arise at heating. Reversely, if the Barcol hardness is more than 25, it is not preferable because the post-working of the molded articles becomes difficult. Also, the molded articles have a Barcol hardness of preferably 5.5 to 22, more preferably 6.0 to 22, in view of heat resistance.

The specific gravity of the molded articles is measured according to JIS K6911, and the measurement shows the values determined in both compression molded articles and injection molded articles. If the specific gravity of the molded articles is less than 1.00, it is not preferable because injection moldability and mechanical strength decrease. Reversely, if the specific gravity of the molded articles is more than 1.6, it is not preferable because there is no difference in specific gravity between the molded articles of the present invention and the conventional BMC, and so lightweight molded articles cannot be obtained. Also, preferably, the molded articles have a specific gravity of 1.01 to 1.45, in view of moldability, mechanical strength and specific gravity.

These physical properties of the molded articles can be easily controlled by changing the addition ratio of BMC.

Further, the molded articles of the present invention preferably have a leveling (smoothness) of 5 to 20. The molded articles in the above leveling range have excellent surface smoothness.

This leveling is measured by using a Wave-scan DOI (BYK Gardner Co., Ltd.) in the short wavelength. If the leveling of the molded articles is more than 20, it is not preferable because the surface smoothness decreases. Also, preferably, the molded articles have a leveling of 7 to 15.

In the molded articles of the present invention, it is especially preferable that the molding shrinkage ratio, the coefficient of linear expansion, Barcol hardness, the specific gravity of the molded articles and the leveling all fulfill the above ranges.

The molded articles of the present invention can be easily obtained by molding the unsaturated polyester resin composition of the present invention according to usual methods. Examples of such molding methods include compression molding, transfer molding, injection molding, etc.

### EXAMPLES

The present invention will now be explained with reference to Examples and Comparative Examples. Also, the present invention is not limited by the following Examples unless the content is exceeded.

In Examples 1-29, the addition ingredients and those amounts shown in Tables 1-4 were used. The ingredients were mixed by using a double-cup type kneader at 30° C., to thereby obtain unsaturated polyester resin compositions.

Resin I used in Examples 1-8 comprises 60% by weight of an unsaturated polyester obtained by polycondensing fumalic acid/propylene glycol/hydrogenated bisphenol A at the ratio of 100 mol/80 mol/20 mol, and 40% by weight of a styrene monomer as a crosslinking agent.

Resin II used in Examples 9-23 and 26-27 comprises 70% by weight of an unsaturated polyester obtained by polycondensing fumalic acid/propylene glycol/neopentyl glycol at the ratio of 100 mol/35 mol/45 mol/20 mol, and 30% by weight of a styrene monomer as a crosslinking agent.

Resin III used in Example 24 comprises 70% by weight of an unsaturated polyester obtained by polycondensing fumalic acid/propylene glycol/neopentyl glycol/hydrogenated bisphenol A at the ratio of 100 mol/25 mol/60 mol/15 mol, and 30% by weight of a styrene monomer as a crosslinking agent.

Resin IV used in Example 25 comprises 70% by weight of an unsaturated polyester obtained by polycondensing fumalic acid/propylene glycol/neopentyl glycol/hydrogenated bisphenol A at the ratio of 100 mol/50 mol/25 mol/25 mol, and 30% by weight of a styrene monomer as a crosslinking agent.

Resin V used in Example 28 comprises 80% by weight of an unsaturated polyester obtained by polycondensing fumalic acid/propylene glycol/neopentyl glycol/hydrogenated bisphenol A at the ratio of 100 mol/35 mol/45 mol/25 mol, and 20% by weight of a styrene monomer as a crosslinking agent.

Resin VI used in Example 29 comprises 70% by weight of an unsaturated polyester obtained by polycondensing maleic anhydride/propylene glycol at the ratio of 100 mol/100 mol, and 30% by weight of a styrene monomer as a crosslinking agent.

These compositions were evaluated for molding shrinkage ratio, coefficient of linear expansion, Barcol hardness, specific gravity, heat resistance, mechanical strength, moldability, surface smoothness and production availability. The method of testing and evaluation was as follows.

(1) Molding Shrinkage Ratio

Shrinkage disks defined in JIS K6911 5.7 were obtained by compression molding at a molding temperature of 150° C. under a molding pressure of 10 MPa for a molding time of 3 minutes. Then, the molding shrinkage ratio was calculated based on JIS K6911 5.7.

(2) Coefficient of Linear Expansion

The test pieces for the bending strength and the bend elastic constant defined in JIS K6911 5.17 were obtained by compression molding at a molding temperature of 150° C. under a molding pressure of 10 MPa for a molding time of 3 minutes. After a test piece was obtained by cutting the testing block to the size of 4×4×20 mm, the coefficient of linear expansion in relation to a temperature rising rate was measured by using a Thermoplus TMA 8310 (Rigaku Co., Ltd) at the temperature rising rate of 2° C./min in a measured temperature range of 40 to 80.

(3) Barcol Hardness when Heated at 180° C.

The shrinkage disks defined in JIS K6911 were obtained by compression molding at a molding temperature of 150° C. under a molding pressure of 10 MPa for a molding time of 3 minutes, and then a test piece was obtained from a shrinkage disk. The test piece was kept in the hot blast cycling drier at 180° C. for 30 minutes. After taking the test piece out of the drier, the Barcol hardness at heating was measured by using a Barcol hardness tester (Barber-Colman Co., Ltd.; GYZJ934-1).

(4) Specific Gravity

1) Specific gravity of the compression molded articles

The shrinkage disks defined in JIS K6911 were obtained by molding at a molding temperature of 150° C. under a molding pressure of 10 MPa for a molding time of 3 minutes. After a test piece was obtained by cutting the shrinkage disk, the specific gravity was measured based on JIS K6911.

2) Specific Gravity of the Injection Molded Articles

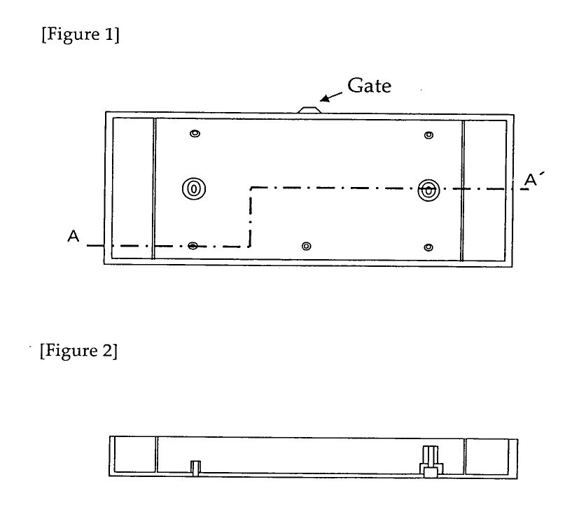

The injection molding was carried out by using an injection molding machine (Niigata Tekkousho Co., Ltd.; NNT250PSCH 7000) in the Test box (360×120×25 mm, wall thickness: 4 mm in a long edge side, 5 mm in a short edge side, 3 mm in a bottom) shown in FIGS. 1 and 2 at a molding temperature of 160° C. under an injection pressure of 30 MPa for a molding time of 2 minutes. After test pieces of the gate part (gate side) and the last filling part (anti-gate side) were obtained by cutting the molded article in the test box, the specific gravity was measured based on JIS K6911.

(5) Heat Resistance (Appearance After Heating)

The disks for measuring the appearance after heating defined in JIS-K6911 were obtained by compression molding at a molding temperature of 150° C. under a molding pressure of 10 MPa for a molding time of 3 minutes. Then, appearance change was evaluated at 180° C., based on Appearance test after heating of JIS K6911. The evaluation is indicated by the symbols (◯: unchanged, ≧: blisters generated, ×: cracks generated) in the Tables.

(6) Mechanical Strength

The test pieces for bending strength and the bend elastic constant defined in JIS K6911 5.17 were obtained by compression molding at a molding temperature of 150° C. under a molding pressure of 10 MPa for a molding time of 3 minutes. Then, the bending strength and bend elastic constant were measured based on JIS K6911.

(7) Moldability

The injection molding was carried out by using an injection molding machine (Niigata Tekkousho Co., Ltd.; NNT250PSCH 7000) in the Test box (360×120×25 mm, wall thickness: 4 mm in a long edge side, 5 mm in a short edge side, 3 mm in a bottom) shown in FIGS. 1 and 2 at a molding temperature of 160° C. under an injection pressure of 30 MPa for a molding time of 2 minutes. The moldability was visually evaluated, and the evaluations are indicated by the symbols ( [symbol] : very good, ◯: good, Δ: inferior, ×: defect) in the Tables.

(8) Surface Smoothness

1) Surface Appearance

The injection molding was carried out by using an injection molding machine (Niigata Tekkousho Co., Ltd.; NNT250PSCH 7000) in the Test box (360×120×25 mm, wall thickness: 4 mm in a long edge side, 5 mm in a short edge side, 3 mm in a bottom) shown in FIGS. 1 and 2 at a molding temperature of 160° C. under an injection pressure of 30 MPa for a molding time of 2 minutes. The surface appearance was visually evaluated, and the evaluations are indicated by the symbols ( [symbol] : very good, ◯: good, Δ: inferior, ×: defect) in the Tables.

2) Leveling

The injection molding was carried out by using an injection molding machine (Niigata Tekkousho Co., Ltd.; NNT250PSCH 7000) in the Test box (360×120×25 mm, wall thickness: 4 mm in a long edge side, 5 mm in a short edge side, 3 mm in a bottom) shown in FIGS. 1 and 2 at a molding temperature of 160° C. under an injection pressure of 30 MPa for a molding time of 2 minutes. The leveling was measured by using a Wave Scan DOI (BYK Gardner Co., Ltd.) both in a long wavelength (Long Wave) and a short wavelength (Short Wave) and evaluated. The preferable evaluation of leveling was carried out in the long wavelength of 10 or less and the short wavelength of 20 or less.

3) Glossiness

The injection molding was carried out by using an injection molding machine (Niigata Tekkousho Co., Ltd.; NNT250PSCH 7000) in the Test box (360×120×25 mm, wall thickness: 4 mm in a long edge side, 5 mm in a short edge side, 3 mm in a bottom) shown in FIGS. 1 and 2 at a molding temperature of 160° C. under an injection pressure of 30 MPa for a molding time of 2 minutes. The glossiness was measured by using a HANDY GLOSS METER PG-1M (Nippon Denshoku Industries Co., Ltd.), based on JIS Z8741 (Specular glossiness—Methods of measurement 3).

(9) Coating Property

The cross-cut adhesion test defined under Adhesion of JIS K5400 8.5 (cut interval: 1 mm) was carried out by using the Test box molding articles used in (4) above. The test was evaluated by the evaluation points defined under Adhesion (Table 18) of JIS K5400 8.5.

The results of the above measurement evaluation are shown in Tables 1-4.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Resin I (styrene monomer content: 40 wt %) | | 55 | 55 | 55 | 55 | 55 | 55 | 55 | 55 |
| Polystylene 40 wt % solution¹⁾ | | 75 | 75 | 75 | 75 | 75 | 75 | 75 | 75 |
| t-butylperoxybenzoate | | 3 | 3 | 3 | 3 | 3 | 3 | 3 | 3 |
| Calcium carbonate (average particle size: 1.8 μm) | | 70 | 210 | 40 | 70 | 70 | — | — | — |
| Calcium carbonate (average particle size: 0.7 μm) | | — | — | — | — | — | 70 | — | — |
| Calcium carbonate (average particle size: 15.0 μm) | | — | — | — | — | — | — | 70 | — |
| Calcium carbonate (average particle size: 25 μm) | | — | — | — | — | — | — | — | 70 |
| Glass balloon (pressure resistance: 2200 × 10⁴ N/m², | | 30 | 90 | 150 | — | — | 30 | 30 | 30 |
| true specific gravity: 0.45) | | | | | | | | | |
| Glass balloon (pressure resistance: 2200 × 10⁴ N/m², | | — | — | — | 30 | — | — | — | — |
| true specific gravity: 0.30) | | | | | | | | | |
| Glass balloon (pressure resistance: 2200 × 10⁴ N/m², | | — | — | — | — | 30 | — | — | — |
| true specific gravity: 0.60) | | | | | | | | | |
| Zinc stearate | | 8 | 8 | 8 | 8 | 8 | 8 | 8 | 8 |
| Chopped glass (6.0 mm) | | 60 | 60 | 60 | 60 | 60 | 60 | 70 | 70 |
| Carbon black | | 2 | 2 | 2 | 2 | 2 | 2 | 2 | 2 |
| Molding shrinkage ratio (%) | | 0.02 | −0.03 | 0.01 | 0.01 | −0.02 | 0 | 0 | 0.01 |
| Coefficient of linear expansion (×10⁻⁵/K) | | 1.7 | 1.4 | 1.6 | 1.8 | 1.7 | 1.5 | 2 | 2 |
| Barcol hardness when heated at 180° C. | | 11 | 12 | 10 | 10 | 13 | 13 | 10 | 10 |
| Specific gravity of compression molded article | | 1.2 | 1.18 | 0.8 | 1.1 | 1.3 | 1.22 | 1.22 | 1.21 |
| Specific gravity of | Gate side | 1.4 | 1.35 | 1.01 | 1.29 | 1.48 | 1.42 | 1.38 | 1.43 |
| injection molded article | Anti-Gate side | 1.4 | 1.34 | 1.01 | 1.28 | 1.49 | 1.42 | 1.38 | 1.42 |
| Heat Resistance (appearance after heating)²⁾ | | ◯ | ◯ | ◯ | ◯ | ◯ | ◯ | ◯ | ◯ |
| Mechanical strength | Bending strength (MPa) | 130 | 125 | 110 | 126 | 133 | 135 | 121 | 80 |
| | Bending elastic constant (GPa) | 10 | 11 | 9 | 10 | 11 | 12 | 10 | 9 |
| Moldability³⁾ | | ⊚ | ⊚ | ◯ | ◯ | ⊚ | ⊚ | ◯ | Δ |
| Surface appearance³⁾ | | ⊚ | ⊚ | ◯ | ◯ | ⊚ | ⊚ | ◯ | Δ |
| Leveling | Long wevelength | 4.2 | 4.5 | 7 | 4 | 6.1 | 3.8 | 7.5 | 5.1 |
| | Short wavelength | 13.7 | 14 | 14.9 | 12.9 | 15.8 | 13 | 16 | 28.4 |

| | | | | | | | | |
|---|---|---|---|---|---|---|---|---|
| Glossiness (%) | 89 | 89 | 84 | 90 | 85 | 90 | 84 | 78 |
| Production availability | avail- | avail- | avail- | avail- | avail- | avail- | avail- | avail- |
| | able | able | able | able | able | able | able | able |

¹⁾Styrene content: 60 wt %
²⁾The meaning of the symbols are as follows: ◯: unchanged, Δ: blisters generated, X: cracks generated
³⁾The meaning of the symbols are as follows: ⊚: very good, ◯: good, Δ: inferior, X: defect

TABLE 2

| | | EX. 9 | EX. 10 | EX. 11 | EX. 12 | EX. 13 | EX. 14 | EX. 15 | EX. 16 | EX. 17 |
|---|---|---|---|---|---|---|---|---|---|---|
| Resin II (stylene monomer content: 30 wt %) | | 71.5 | 71.5 | 71.5 | 71.5 | 93 | 43 | 71.5 | 71.5 | 71.5 |
| Polystyrene | | 30 | 30 | 30 | 30 | 30 | 30 | 30 | 30 | 30 |
| Styrene monomer | | 26 | 23.5 | 18.5 | 16 | 5.3 | 39.5 | 23.5 | 23.5 | 23.5 |
| diallylphthalate monomer | | 2.5 | 5 | 10 | 12.5 | 1.7 | 17.5 | — | 5 | 5 |
| diallylphthalate prepolymer | | — | — | — | — | — | — | 5 | — | — |
| t-butylperoxybenzoate | | 3 | 3 | 3 | 3 | 3 | 3 | 3 | 3 | 3 |
| Calcium carbonate (average particle size: 1.8 μm) | | 70 | 70 | 70 | 70 | 70 | 70 | 70 | 70 | 200 |
| Glass balloon (pressure resistance: 2200 × 10⁴ N/m², | | 30 | 30 | 30 | 30 | 30 | 30 | 30 | 30 | 85 |
| true specific gravity: 0.45) | | | | | | | | | | |
| Zinc stearate | | 8 | 8 | 8 | 8 | 8 | 8 | 8 | 8 | 8 |
| Chopped glass (6.0 mm) | | 60 | 60 | 60 | 60 | 60 | 60 | 60 | 60 | 60 |
| Carbon black | | 2 | 2 | 2 | 2 | 2 | 2 | 2 | 2 | 2 |
| (A)/(B) | | 5/95 | 10/90 | 20/80 | 25/75 | 5/95 | 25/75 | 10/90 | 10/90 | 10/90 |
| Parts by weight of crosslinking agent ((A) + (B)) | | 50 | 50 | 50 | 50 | 35 | 70 | 50 | 50 | 50 |
| based on 100 parts by weight of the unsaturated | | | | | | | | | | |
| polyester resin and the crosslinking agent | | | | | | | | | | |
| Molding shrinkage ratio (%) | | 0.02 | 0.02 | 0.01 | 0.01 | 0.02 | 0.01 | 0.01 | 0.02 | −0.03 |
| Coefficient of linear expansion (×10⁻⁵/K) | | 1.7 | 1.7 | 1.6 | 1.8 | 1.7 | 1.8 | 1.9 | 1.7 | 1.4 |
| Barcol hardness when heated at 180° C. | | 11 | 11 | 11 | 11 | 11 | 11 | 10 | 11 | 12 |
| Specific gravity of compression molded article | | 1.2 | 1.21 | 1.2 | 1.21 | 1.2 | 1.22 | 1.22 | 1.2 | 1.18 |
| Specific gravity of injection | Gate side | 1.4 | 1.39 | 1.41 | 1.39 | 1.38 | 1.41 | 1.38 | 1.4 | 1.35 |
| molded article | Anti-Gate side | 1.4 | 1.39 | 1.41 | 1.38 | 1.39 | 1.4 | 1.39 | 1.4 | 1.34 |
| Heat Resistance (appearance after heating)¹⁾ | | ◯ | ◯ | ◯ | ◯ | ◯ | ◯ | ◯ | ◯ | ◯ |
| Mechanical strength | Bending strength (MPa) | 130 | 135 | 130 | 136 | 133 | 135 | 131 | 130 | 125 |
| | Bending elastic constant (GPa) | 10 | 11 | 10 | 10 | 11 | 11 | 10 | 10 | 11 |
| Moldability²⁾ | | ⊚ | ⊚ | ⊚ | ⊚ | ◯ | ⊚ | ⊚ | ⊚ | ⊚ |
| Surface appearance²⁾ | | ⊚ | ⊚ | ⊚ | ⊚ | ◯ | ⊚ | ⊚ | ⊚ | ⊚ |
| Leveling | Long wevelength | 4.2 | 4.5 | 4.5 | 4.2 | 4.4 | 7.1 | 4.5 | 4.2 | 4.5 |
| | Short wavelength | 13.7 | 14 | 14.9 | 12.9 | 15.8 | 18 | 16 | 13.7 | 14 |
| Glossiness (%) | | 89 | 89 | 84 | 90 | 85 | 81 | 84 | 89 | 89 |
| Coating property | Point | 8 | 9 | 9 | 10 | 7 | 10 | 9 | 9 | 9 |
| | Assessment³⁾ | ◯ | ⊚ | ⊚ | ⊚ | ◯ | ⊚ | ⊚ | ⊚ | ⊚ |

| | | | | | | | | | |
|---|---|---|---|---|---|---|---|---|---|
| Production availability | avail- | avail- | avail- | avail- | avail- | avail- | avail- | avail- | avail- |
| | able | able | able | able | able | able | able | able | able |

¹⁾The meaning of the symbols are as follows: ◯: unchanged, Δ: blisters generated, X: cracks generated
²⁾The meaning of the symbols are as follows: ⊚: very good, ◯: good, Δ: inferior, X: defect
³⁾The meaning of the symbols are as follows: ⊚: 9 or more, ◯: 8-7, Δ: 6-5, X: 4 or less

TABLE 3

| | | EX. 18 | EX. 19 | EX. 20 | EX. 21 | EX. 22 | EX. 23 | EX. 24 | EX. 25 |
|---|---|---|---|---|---|---|---|---|---|
| Resin II (stylene monomer content: 30 wt %) | | 71.5 | 71.5 | 71.5 | 71.5 | 71.5 | 71.5 | — | — |
| Resin III (stylene monomer content: 30 wt %) | | — | — | — | — | — | — | 71.5 | — |
| Resin IV (stylene monomer content: 30 wt %) | | — | — | — | — | — | — | — | 71.5 |
| Polystyrene | | 30 | 30 | 30 | 30 | 30 | 30 | 30 | 30 |
| Styrene monomer | | 23.5 | 23.5 | 23.5 | 23.5 | 23.5 | 23.5 | 23.5 | 23.5 |
| diallylphthalate monomer | | 5 | 5 | 5 | 5 | 5 | 5 | 5 | 5 |
| t-butylperoxybenzoate | | 3 | 3 | 3 | 3 | 3 | 3 | 3 | 3 |
| Calcium carbonate (average particle size: 1.8 μm) | | 40 | 70 | 70 | — | — | 70 | 70 | 70 |
| Calcium carbonate (average particle size: 0.7 μm) | | — | — | — | 70 | — | — | — | — |
| Calcium carbonate (average particle size: 15.0 μm) | | — | — | — | — | 70 | — | — | — |
| Glass balloon (pressure resistance: 2200 × 10⁴ N/m², | | 150 | — | — | 30 | 30 | 30 | 30 | 30 |
| true specific gravity: 0.45) | | | | | | | | | |
| Glass balloon (pressure resistance: 2200 × 10⁴ N/m², | | — | 30 | — | — | — | — | — | — |
| true specific gravity: 0.30) | | | | | | | | | |
| Glass balloon (pressure resistance: 2200 × 10⁴ N/m², | | — | — | 30 | — | — | — | — | — |
| true specific gravity: 0.60) | | | | | | | | | |
| Zinc stearate | | 8 | 8 | 8 | 8 | 8 | 8 | 8 | 8 |
| Chopped glass (6.0 mm) | | 60 | 60 | 60 | 60 | 70 | 60 | 60 | 60 |
| Carbon black | | 2 | 2 | 2 | 2 | 2 | 2 | 2 | 2 |
| (A)/(B) | | 10/90 | 10/90 | 10/90 | 10/90 | 10/90 | 10/90 | 10/90 | 10/90 |
| Parts by weight of crosslinking agent ((A) + (B)) | | 50 | 50 | 50 | 50 | 50 | 50 | 50 | 50 |
| based on 100 parts by weight of the unsaturated | | | | | | | | | |
| polyester resin and the crosslinking agent | | | | | | | | | |
| Molding shrinkage ratio (%) | | 0.01 | 0.01 | -0.02 | 0 | 0 | 0.02 | 0.03 | 0.01 |
| Coefficient of linear expansion (×10⁻⁵/K) | | 1.6 | 1.8 | 1.7 | 1.5 | 2 | 1.8 | 1.7 | 1.7 |
| Barcol hardness when heated at 180° C. | | 12 | 11 | 11 | 11 | 11 | 11 | 11 | 11 |
| Specific gravity of compression molded article | | 0.8 | 1.1 | 1.3 | 1.22 | 1.22 | 1.2 | 1.19 | 1.19 |
| Specific gravity of injection | Gate side | 1.01 | 1.29 | 1.48 | 1.42 | 1.38 | 1.4 | 1.37 | 1.38 |
| molded article | Anti-Gate side | 1.01 | 1.28 | 1.49 | 1.42 | 1.38 | 1.4 | 1.39 | 1.38 |
| Heat Resistance (appearance after heating)¹⁾ | | ◯ | ◯ | ◯ | ◯ | ◯ | ◯ | ◯ | ◯ |
| Mechanical strength | Bending strength (MPa) | 110 | 126 | 133 | 135 | 121 | 130 | 135 | 130 |
| | Bending elastic constant (GPa) | 9 | 10 | 11 | 12 | 10 | 10 | 11 | 10 |
| Moldability²⁾ | | ◯ | ◯ | ⊚ | ⊚ | ◯ | ⊚ | ⊚ | ⊚ |
| Surface appearance²⁾ | | ◯ | ◯ | ⊚ | ⊚ | ◯ | ⊚ | ⊚ | ⊚ |
| Leveling | Long wevelength | 7 | 4 | 6.1 | 3.8 | 7.5 | 4.2 | 4.5 | 4.2 |
| | Short wavelength | 14.9 | 12.9 | 15.8 | 13 | 16 | 13.7 | 14 | 14.3 |
| Glossiness (%) | | 84 | 90 | 85 | 90 | 84 | 89 | 89 | 84 |
| Coating property | Point | 9 | 9 | 9 | 9 | 9 | 9 | 9 | 9 |
| | Assessment³⁾ | ⊚ | ⊚ | ⊚ | ⊚ | ⊚ | ⊚ | ⊚ | ⊚ |

| | | | | | | | | |
|---|---|---|---|---|---|---|---|---|
| Production availability | avail- | avail- | avail- | avail- | avail- | avail- | avail- | avail- |
| | able | able | able | able | able | able | able | able |

¹⁾The meaning of the symbols are as follows: ◯: unchanged, Δ: blisters generated, X: cracks generated
²⁾The meaning of the symbols are as follows: ⊚: very good, ◯: good, Δ: inferior, X: defect
³⁾The meaning of the symbols are as follows: ⊚: 9 or more, ◯: 8-7, Δ: 6-5, X: 4 or less

TABLE 4

| | | Ex. 26 | Ex. 27 | Ex. 28 | Ex. 29 |
|---|---|---|---|---|---|
| Resin II (stylene monomer content: 30 wt %) | | 71.5 | 71.5 | — | — |
| Resin V (stylene monomer content: 20 wt %) | | — | — | 94 | — |
| Resin VI (stylene monomer content: 30 wt %) | | — | — | — | 71.5 |
| Polystyrene | | 30 | 30 | 30 | 30 |
| Styrene monomer | | 28.5 | 13.5 | 4.7 | 23.5 |
| diallylphthalate monomer | | — | 15 | 1.3 | 5 |
| t-butylperoxybenzoate | | 3 | 3 | 3 | 3 |
| Calcium carbonate (average particle size: 1.8 μm) | | 70 | 70 | 70 | 70 |
| Calcium carbonate (average particle size: 0.2 μm) | | — | — | — | — |
| Glass balloon (pressure resistance: 2200 × 10⁴ N/m², | | 30 | 30 | 30 | 30 |
| true specific gravity: 0.45) | | | | | |
| Glass balloon (pressure resistance: 1600 × 10⁴ N/m², | | — | — | — | — |
| true specific gravity: 0.45) | | | | | |
| Zinc stearate | | 8 | 8 | 8 | 8 |
| Chopped glass (6.0 mm) | | 60 | 60 | 60 | 60 |
| Carbon black | | 2 | 2 | 2 | 2 |
| (A)/(B) | | 0/100 | 30/70 | 5/95 | 10/90 |
| Parts by weight of crosslinking agent ((A) + (B)) based on 100 parts by | | 50 | 50 | 25 | 50 |
| weight of the unsaturated polyester resin and the crosslinking agent | | | | | |
| Molding shrinkage ratio (%) | | 0.02 | 0.02 | 0.05 | 0.01 |
| Coefficient of linear expansion (×10⁻⁵/K) | | 1.7 | 1.7 | 1.7 | 1.3 |
| Barcol hardness when heated at 180° C. | | 11 | 10 | 10 | 11 |
| Specific gravity of compression molded article | | 1.2 | 1.2 | 1.21 | 1.2 |
| Specific gravity of injection | Gate side | 1.4 | 1.41 | 1.51 | 1.41 |
| molded article | Anti-Gate side | 1.41 | 1.41 | 1.5 | 1.41 |
| Heat Resistance (appearance after heating)¹⁾ | | ◯ | Δ | Δ | ◯ |
| Mechanical strength | Bending strength (MPa) | 135 | 125 | 123 | 135 |
| | Bending elastic constant (GPa) | 10 | 9 | 11 | 10 |
| Moldability²⁾ | | ⊚ | Δ | Δ | Δ |
| Surface appearance²⁾ | | ⊚ | Δ | Δ | Δ |
| Leveling | Long wavelength | 4.5 | 10.2 | 11.8 | 10.1 |
| | Short wavelength | 13.8 | 19.5 | 25 | 19.9 |
| Glossiness (%) | | 88 | 73 | 74 | 73 |
| Coating property | Point | 5 | 9 | 6 | 9 |
| | Assessment³⁾ | Δ | ⊚ | Δ | ⊚ |

| | | | | |
|---|---|---|---|---|
| Production availability | available | available | available | available |

¹⁾The meaning of the symbols are as follows: ◯: unchanged, Δ: blisters generated, X: cracks generated
²⁾The meaning of the symbols are as follows: ⊚: very good, ◯: good, Δ: inferior, X: defect
³⁾The meaning of the symbols are as follows: ⊚: 9 or more, ◯: 8-7, Δ: 6-5, X: 4 or less

As shown in Tables 1-4, in all examples, destruction of the hollow filler in the production step and the molding step was considerably small, and thereby the specific gravity of the molded articles were stably 1.6 or less and also there were no variations of specific gravity between parts of the molded articles. Further, molded articles having excellent heat resistance, surface smoothness, dimensional accuracy, mechanical strength and moldability were obtained. Further, in the examples using diallylphthalate monomer or prepolymer (A) and a radical polymeric unsaturated monomer other than diallylphthalate monomer (B) as a crosslinking agent, molded articles having excellent coating properties were obtained.

In addition, when an inorganic filler having an average particle size of 15.0 μm or less was used, the mechanical strength, moldability and surface appearance considerably increased. Also, when the specific gravities both in the compression molded articles and the injection molded articles were in the range of 1.00 to 1.60, the mechanical strength was particularly excellent.

On the other hand, in Comparative Examples 1-18, the addition ingredients and those amounts shown in Tables 5-6 were used. Along with the examples 1-29, the ingredients were mixed by using a double-cup type kneader, to thereby obtain unsaturated polyester resin compositions.

Further, along with the examples, the molding shrinkage ratio, coefficient of linear expansion, Barcol hardness, specific gravity, heat resistance, mechanical strength, moldability, surface smoothness and production availability were evaluated.

These results of this measurement evaluation are shown in Tables 5-6.

TABLE 5

| | | Co- | Co- | Co- | Co- | Co- | Co- | Co- | Co- | Co- |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 |
| Resin I (styrene monomer content: 40 wt %) | | 55 | 55 | 55 | 55 | 55 | 55 | 55 | 55 | 55 |
| Polystylene 40 wt % solution¹⁾ | | 75 | 75 | 75 | 75 | 75 | 75 | 75 | 75 | 75 |
| t-butylperoxybenzoate | | 3 | 3 | 3 | 3 | 3 | 3 | 3 | 3 | 3 |
| Calcium carbonate (average particle size: 1.8 μm) | | 40 | 40 | 70 | 200 | 250 | 20 | 70 | 70 | — |
| Calcium carbonate (average particle size: 0.2 μm) | | — | — | — | — | — | — | — | — | 70 |
| Glass balloon (pressure resistance: 2200 × 10⁴ N/m², | | 200 | 250 | 15 | 30 | 150 | 80 | — | — | 30 |
| true specific gravity: 0.45) | | | | | | | | | | |
| Glass balloon (pressure resistance: 1600 × 10⁴ N/m², | | — | — | — | — | — | — | 30 | 60 | — |
| true specific gravity: 0.45) | | | | | | | | | | |
| Zinc stearate | | 8 | 8 | 8 | 8 | 8 | 8 | 8 | 8 | 8 |
| Chopped glass (6.0 mm) | | 60 | 60 | 60 | 60 | 60 | 60 | 60 | 60 | 70 |
| Carbon black | | 2 | 2 | 2 | 2 | 2 | 2 | 2 | 2 | 2 |
| Molding shrinkage ratio (%) | | 0.04 | — | −0.02 | 0 | — | 0.03 | 0 | 0 | — |
| Coefficient of linear expansion (×10⁻⁵/K) | | 1.6 | — | 1.9 | 2 | — | 2.5 | 2.7 | 2.6 | — |
| Barcol hardness when heated at 180° C. | | 8 | — | 11 | 15 | — | 3 | 7 | 2 | — |
| Specific gravity of compression molded article | | 0.82 | — | 1.4 | 1.51 | — | 0.9 | 1.55 | 1.28 | — |
| Specific gravity of injection | Gate side | 1 | — | 1.65 | 1.7 | — | 1.67 | 1.41 | 1.15 | — |
| molded article | Anti-Gate side | 0.91 | — | 1.64 | 1.7 | — | 1.58 | 1.5 | 1.1 | — |
| Heat Resistance (appearance after heating)²⁾ | | Δ | — | ◯ | ◯ | — | Δ | Δ, X | Δ, x | — |
| Mechanical strength | Bending strength (MPa) | 50 | — | 130 | 135 | — | 125 | 75 | 70 | — |
| | Bending elastic | 7 | — | 12 | 12 | — | 9 | 6 | 7 | — |
| Moldability³⁾ | | X | — | ⊚ | ⊚ | — | X | ⊚ | Δ | — |
| Surface appearance³⁾ | | X | — | ⊚ | ⊚ | — | X | ⊚ | Δ | — |
| Leveling | Long wevelength | 11 | — | 4.5 | 4.5 | — | 9.7 | 11.1 | 10.5 | — |
| | Short wavelength | 25 | — | 13.1 | 13.1 | — | 13.6 | 25.3 | 33 | — |

| | | | | | | | | | |
|---|---|---|---|---|---|---|---|---|---|
| Glossiness (%) | 70 | — | 88 | 88 | — | 73 | 89 | 81 | — |
| Production availability | avail- | non- | avail- | avail- | non- | avail- | avail- | avail- | non- |
| | able | avail- | able | able | avail- | able | able | able | avail- |
| | | able | | | able | | | | able |

¹⁾Styrene content: 60 wt %
²⁾The meaning of the symbols are as follows: ◯: unchanged, Δ: blisters generated, X: cracks generated
³⁾The meaning of the symbols are as follows: ⊚: very good, ◯: good, Δ: inferior, X: defect

TABLE 6

| | | Co- | Co- | Co- | Co- | Co- | Co- | Co- | Co- | Co- |
|---|---|---|---|---|---|---|---|---|---|---|
| | | Ex. 10 | Ex. 11 | Ex. 12 | Ex. 13 | Ex. 14 | Ex. 15 | Ex. 16 | Ex. 17 | Ex. 18 |
| Resin II (stylene monomer content: 30 wt %) | | 71.5 | 71.5 | 71.5 | 71.5 | 71.5 | 71.5 | 71.5 | 71.5 | 71.5 |
| Polystyrene | | 30 | 30 | 30 | 30 | 30 | 30 | 30 | 30 | 30 |
| Styrene monomer | | 23.5 | 23.5 | 23.5 | 23.5 | 23.5 | 23.5 | 23.5 | 23.5 | 23.5 |
| diallylphthalate monomer | | 5 | 5 | 5 | 5 | 5 | 5 | 5 | 5 | 5 |
| t-butylperoxybenzoate | | 3 | 3 | 3 | 3 | 3 | 3 | 3 | 3 | 3 |
| Calcium carbonate (average particle size: 1.8 μm) | | 40 | 40 | 70 | 200 | 250 | 20 | 70 | 70 | — |
| Calcium carbonate (average particle size: 0.2 μm) | | — | — | — | — | — | — | — | — | 70 |
| Glass balloon (pressure resistance: 2200 × 10⁴ N/m², | | 200 | 250 | 15 | 30 | 150 | 80 | — | — | 30 |
| true specific gravity: 0.45) | | | | | | | | | | |
| Glass balloon (pressure resistance: 1600 × 10⁴ N/m², | | — | — | — | — | — | — | 30 | 60 | — |
| true specific gravity: 0.45) | | | | | | | | | | |
| Zinc stearate | | 8 | 8 | 8 | 8 | 8 | 8 | 8 | 8 | 8 |
| Chopped glass (6.0 mm) | | 60 | 60 | 60 | 60 | 60 | 60 | 60 | 60 | 70 |
| Carbon black | | 2 | 2 | 2 | 2 | 2 | 2 | 2 | 2 | 2 |
| (A)/(B) | | 10/90 | 10/90 | 10/90 | 10/90 | 10/90 | 10/90 | 10/90 | 10/90 | 10/90 |
| Parts by weight of crosslinking agent ((A) + (B)) | | 50 | 50 | 50 | 50 | 50 | 50 | 50 | 50 | 50 |
| based on 100 parts by weight of the unsaturated | | | | | | | | | | |
| polyester resin and the crosslinking agent | | | | | | | | | | |
| Molding shrinkage ratio (%) | | 0.03 | — | −0.02 | 0 | — | 0.03 | 0 | 0 | — |
| Coefficient of linear expansion (×10⁻⁵/K) | | 2.5 | — | 1.9 | 2 | — | 2.5 | 2.7 | 2.6 | — |
| Barcol hardness when heated at 180° C. | | 8 | — | 10 | 14 | — | 5 | 5 | 5 | — |
| Specific gravity of compression molded article | | 0.9 | — | 1.4 | 1.51 | — | 0.9 | 1.55 | 1.28 | — |
| Specific gravity of injection | Gate side | 1.67 | — | 1.65 | 1.7 | — | 1.15 | 1.67 | 1.41 | — |
| molded article | Anti-Gate side | 1.58 | — | 1.64 | 1.7 | — | 1.1 | 1.58 | 1.5 | — |
| Heat Resistance (appearance after heating)¹⁾ | | Δ | — | ◯ | ◯ | — | Δ | Δ, X | Δ, X | — |
| Mechanical strength | Bending strength (MPa) | 125 | — | 130 | 135 | — | 70 | 125 | 75 | — |
| | Bending elastic constant (GPa) | 9 | — | 12 | 12 | — | 7 | 9 | 6 | — |
| Moldability²⁾ | | X | — | ⊚ | ⊚ | — | X | ⊚ | Δ | — |
| Surface appearance²⁾ | | X | — | ⊚ | ⊚ | — | X | ⊚ | Δ | — |
| Leveling | Long wevelength | 9.7 | — | 4.5 | 4 | — | 10.5 | 9.7 | 11.1 | — |
| | Short wavelength | 13.6 | — | 13.1 | 12.7 | — | 33 | 13.6 | 25.3 | — |
| Glossiness (%) | | 73 | — | 88 | 88 | — | 73 | 89 | 81 | — |
| Coating property | Point | 9 | — | 9 | 9 | — | 9 | 9 | 9 | — |
| | Assessment³⁾ | ⊚ | — | ⊚ | ⊚ | — | ⊚ | ⊚ | ⊚ | — |

| | | | | | | | | | |
|---|---|---|---|---|---|---|---|---|---|
| Production availability | avail- | non- | avail- | avail- | non- | avail- | avail- | avail- | non- |
| | able | avail- | able | able | avail- | able | able | able | avail- |
| | | able | | | able | | | | able |

¹⁾The meaning of the symbols are as follows: ◯: unchanged, Δ: blisters generated, X: cracks generated
²⁾The meaning of the symbols are as follows: ⊚: very good, ◯: good, Δ: inferior, X: defect
³⁾The meaning of the symbols are as follows: ⊚: 9 or more, ◯: 8-7, Δ: 6-5, X: 4 or less

As shown in Tables 5-6, in the unsaturated polyester resin composition in which the addition amount of the inorganic filler and the hollow filler and the addition ratio by weight of the inorganic filler to the hollow filler were outside of the above specified range, and a large amount of the hollow filler was added, the heat resistance, surface smoothness, mechanical strength, moldability and molded article appearance considerably decreased, or the molded article could not be produced. Reversely, when the amount of the hollow filler in the unsaturated polyester resin compositions was not sufficient, molded articles having sufficient specific gravity could not be obtained. Similarly, unsaturated polyester resin compositions in which large amounts of the inorganic filler were added could not obtain molded articles having sufficient specific gravity. Reversely, in the unsaturated polyester resin compositions having insufficient amounts of the inorganic filler, the mechanical strength, moldability and molded article appearance considerably decreased.

Further, in the unsaturated polyester resin compositions in which the pressure strength of the hollow filler did not fulfill the above specified range, the hollow filler was destroyed in the production step and the molding step, and thereby the specific gravity of the molded articles increased and the heat resistance decreased. Reversely, in the unsaturated polyester resin compositions in which a large amount of the hollow filler was added, molded articles having sufficient heat resistance, surface smoothness, mechanical strength and moldability could not be obtained.

On the other hand, in the unsaturated polyester resin compositions in which the average particle size of the inorganic filler was less than the above specified value, the viscosity of the composition became high, and thereby molded articles could not be produced.

Furthermore, in the unsaturated polyester resin compositions in which the specific gravity of the compression molded article and Barcol hardness were outside of the above specified range, it was clear that the heat resistance was inferior.

Therefore, it is clear that the molded articles obtained by the unsaturated polyester resin compositions characterized by comprising the inorganic filler and the hollow filler according to the present invention differs from conventional molded articles, and has a balanced and low specific gravity, excellent heat resistance, surface smoothness, mechanical property, moldability, etc. Further, it is clear that the molded articles obtained by the unsaturated polyester resin compositions using diallylphthalate monomer or prepolymer and a radical polymeric unsaturated monomer other than diallylphthalate monomer further have excellent coating properties.

Accordingly, the molded articles of the present invention obtained by the unsaturated polyester resin composition are remarkably useful in the field of lamp reflectors which require high heat resistance, surface smoothness and mechanical properties, such as automotive head lamps, etc., and can be used in a broad range.

1. A low specific gravity unsaturated polyester resin composition for lamp reflectors, characterized in that the compositions comprise from 40 to 210 parts by weight of an inorganic filler having an average particle size of at least 0.5 μm of and from 30 to 160 parts by weight of a hollow filler having a pressure resistance of at least 2,100×10⁴ N/m² based on 100 parts by weight of an unsaturated polyester resin and a crosslinking agent wherein the addition ratio by weight of the inorganic filler to the hollow filler lies within a range of 2:8 to 8:2.

2. A low specific gravity unsaturated polyester resin composition for lamp reflectors according to claim 1, characterized in that the compositions comprise from 35 to 75 parts by weight of the crosslinking agent based on 100 parts by weight of the unsaturated polyester resin and the crosslinking agent, said crosslinking agent comprised of diallylphthalate monomer or prepolymer (A) and a crosslinking agent other than diallylphthalate monomer (B) wherein the ratio by weight of the (A) to (B) lies in a range of 5:95 to 25:75.

3. A low specific gravity unsaturated polyester resin composition for lamp reflectors according to claim 1, characterized in that said polyester resin is obtained by polycondensing a total of 100 moles consisting of 20 to 50 moles of propylene glycol, 25 to 65 moles of neopentyl glycol and 15 to 25 moles of bisphenol A or hydrogenated bisphenol A based on 100 moles of at least one unsaturated polybasic acid selected from a group formed from fumaric acid and maleic anhydride.

4. A low specific gravity unsaturated polyester resin composition for lamp reflectors according to claim 1, characterized in that the inorganic filler has an average particle size of 15 μm or less.

5. A low specific gravity unsaturated polyester resin composition for lamp reflectors according to claim 1, characterized in that the hollow filler has a true specific gravity of 0.3 to 0.7.

6. A low specific gravity unsaturated polyester resin composition for lamp reflectors according to claim 1, characterized in that molded articles of the resin compositions have a molding shrinkage ratio of −0.15 to +0.05%, a coefficient of linear expansion of 1.0×10⁻⁵/K to 2.5×10⁻⁵/K, Barcol hardness of 5 to 25 when heated at 180° C. and a specific gravity of 1.00 to 1.60.

7. A low specific gravity unsaturated polyester resin composition for lamp reflectors according to claim 1, characterized in that the molded articles of the resin compositions have a leveling of 5 to 20.

8. A molded article obtained by molding the low specific gravity unsaturated polyester resin compositions for lamp reflectors according to claim 1.

9. A molded article according to claim 8, characterized in that the molded article has a molding shrinkage ratio of −0.15 to +0.05%, a coefficient of linear expansion of 1.0×10⁻⁵/K to 2.5×10⁻⁵/K, Barcol hardness of 5 to 25 when heated at 180° C. and a specific gravity of 1.00 to 1.60.
